(19) United States
(12) Patent Application Publication
(10) Pub. No.: US 2002/0087734 A1
(43) Pub. Date: Jul. 4, 2002

(54) System and method for managing dependencies in a component-based system

(76) Inventors: Donald Brent Marshall, Ottawa (CA); Christian C. Ellens, Nepean (CA); Thomas Lismer, Ottawa (CA)

Correspondence Address: Hunton & Williams, 1900 K Street, N.W., Washington, DC, 20006-1109, US

(21) Appl. No.: 09/750,305

(22) Filed: Dec. 29, 2000

(51) Int. Cl. G06F 9/44; G06F 15/163

(52) U.S. Cl. 709/310

(57) ABSTRACT

A system and method for managing dependencies in a component-based system. The process includes defining a resource that is part of an entity, recording a resource specifier for the resource, and recording resource dependency relationships definitions for the resource. The resource and its dependency relationships may the be deployed to a system. The deployment may include verifying the existence of all dependency relationship resources of the resource on the system and transmitting a warning if any of the dependencies of the are unsatisfied. The deployment may also include creating an abstract resource if the abstract resource recorded as a dependency is not found on the system to which the resource is being deployed. The abstract resource may be created based on the dependency relationship definition of the abstract resource. If any dependency relationship is unsatisfied, and deployment can not be completed without the dependency, deployment may be ended. Furthermore, during runtime, the dependency information will be used to create relationships between the management proxies for the resources, thereby providing intelligent control of management state based on these relationships.

The subject matter of this application is related to the subject matter of copending U.S. Patent application Ser. Nos.______, entitled “System and Method for Managing a Component-Based System,” “Method and System for Integrated Resource Management,” “System and Method for Flexible Network Service Application Components,” and “Method and System for Distributing Services,” respectively, each filed the same day as this application and each being assigned or under obligation of assignment to the same assignee as this application, and each also incorporated by reference.

### FIELD OF THE INVENTION

This invention relates generally to software deployment and management, and more particularly to the tracking, verification, and management of dependencies of software upon resources in its target deployment environment.

### BACKGROUND OF THE INVENTION

In networks, there may often exist incompatibilities among various components and other hardware. In a cell phone network, different cell phone equipment may have varying requirements for proper and efficient communication. A mobile switching office (“MSO”) may receive cell phone (or other) transmissions to route the transmissions to the network or resource (e.g., database). Generally, a server may be configured to format to a specific database (or other resource). Each component of a network is highly dependent on each other for compatibility and proper communication.

For example, cellular telephone calls through a telecommunications network may be routed through a Mobile Switching Offices (MSO). The calls may be received at a base station which acts as a translator for phone numbers, etc. The MSO may access resources (e.g., a 800 number database) through a server or route calls to a public switched telephone network (PSTN).

If a database (or other resource) is to be removed (or otherwise modified), reconfiguration of the server and other components may be required. This may entail downing the system, making the necessary modifications, loading software, rebooting, and performing other additional operations. Thus, if a phone server (or other types of inquiries) are modified (e.g., upgraded, etc.), changes in hardware and other components in a mobile switching office may be necessary.

Further, within a network, resources generally involve databases, network addresses, software to be retrieved, and other hardware used to support connections. Due to the high dependency on components for compatibility, resources have been traditionally hardwired to various components within a network. Essentially, every device in a chain had to know of devices in the rest of the chain to obtain the requested information.

If a resource in a particular application is unavailable due to failure or other disability, dependent resources are not always aware of the unavailability until the disabled resource is accessed. For example, if a service requires a communication channel to a remote node, and that communication channel goes down, then the service is also down. Since the communication channel does not know what is dependent upon it, there is no way for the communication channel to give explicit notification to its dependent resources. Thus, the service may not know that the communication channel is down until it tries to use it.

Software almost always has dependencies upon entities external to itself. For example, a program may depend upon the availability of certain files (such as icons, HTML files, configuration files, graphics files, etc), other programs, hardware capabilities (such as the ability to display, print, play sound, etc.), library code (such as dynamically linked libraries (DLLs), Java class files or JARs, etc.), specific database tables, and/or specific LDAP directories.

In order to ensure the reliable functioning of the software in its target deployment environment, it is desirable to verify these dependencies. Software which is deployed into environments where some of its dependencies are not satisfied may not run at all. Or, in an even worse situation, the software may appear to run properly for a period of time but when an attempt is made to access a missing dependency, the software may behave in unpredictable ways. This makes it difficult to diagnose and resolve the cause of a deployment problem.

Furthermore, it may be desirable to monitor dependencies at runtime and tie them into the management of the software in order to ensure the ongoing correct operation of the software, and to provide precise diagnostic information to allow the fast resolution of problems.

For example, if a transaction processing program depends upon the availability of a database server, the program may stop functioning correctly if that database goes down, or network connectivity to it is lost. Typical management behavior in such a situation would be to generate a log for each failed transaction. The large volume of such logs may give the incorrect impression that there is a serious problem with the transaction processing system. Instead, it would be desirable for the dependency of the transaction processing program upon the database to be monitored. When the database becomes unavailable, this should cause the transaction processing program to become unavailable, with an indication that the reason for its unavailability is the lack of access to its database.

Likewise, it is desirable that various system operations, such as system startup and initialization, reseting, shutdown, etc., behave appropriately based on dependencies. For example, if an entity A must establish a connection to another entity B as part of its startup and initialization sequence, then A must wait until B has started up before it executes this phase of its initialization.

The lack of systems to track, verify, and manage these dependencies is one of the main sources of difficulty for those trying to reliably deploy different configurations of software to target execution environments.

Currently there is no uniform, comprehensive approach available to track and verify dependencies of software upon its target environment. Typically this is handled manually by listing requirements in documentation, and having the person deploying the new software check whether the dependencies are met. This is a haphazard, time-consuming and unreliable approach.

Sometimes, specialized installer software will have the ability to check a subset of the dependencies. However, the software may be complicated and tedious to write and maintain, since it may use different approaches to verify each different type of dependency.

Furthermore, there is no uniform, comprehensive approach to monitoring dependencies at runtime. Typically failures in one part of a system may cause unpredictable behavior in dependent parts of the system. Operations Administration and Maintenance (“OAM”) systems may present large amounts of information about the various failures and strange behavior in the system, with no clear indication of whether they are correlated in any way, and no indication of which failure represents the root cause. Administrative personnel are often left to diagnose the cause of the problems based on their experience. They are often hindered by the abundance of misleading information about failures which may be direct or indirect results of the root cause failure.

Many attempts have been made to correlate symptoms of problems presented in an OAM system (for example, using expert systems) to attempt to provide a root cause diagnosis given a large number of failure indications. These attempts have met with limited success for a number of reasons. First, the rules for correlating the failures to diagnose a root cause must evolve with different configurations and versions of the runtime software. The maintenance of these rules is difficult, costly, and time-consuming. Second, the reliability of the diagnosis is fundamentally limited by the fact that it is based on black-box observation of the overall system's behavior.

For example, due to race conditions, the same root cause failure may result in a different sequence of failure indications being presented. This, in turn, may result in different diagnoses, even though the actual root cause failure is the same. Likewise, there is currently no comprehensive, uniform system for allowing dependencies to automatically control startup and initialization, reset and shutdown sequences. Instead, there is typically a combination of ad hoc techniques used to work around this limitation. Often, a system will have a hard-coded initialization script or routine which drives the initialization of each system component in the correct order.

There are a number of problems with this approach. First, the script is difficult and troublesome to maintain, since it must be updated as components are added, removed or modified, and the relationships between components may not be readily apparent. Second, this approach typically extends startup latency of a system, since it reduces or eliminates parallelism in the startup sequence, instead driving the initialization of each component sequentially.

### SUMMARY OF THE INVENTION

A system and method for managing dependencies in a component-based system is described.

In one aspect of the invention, the process includes defining a resource that is part of an entity, recording a resource specifier for the resource, and recording resource dependency relationships definitions for the resource. The resource and its dependency relationships may the be deployed to a system. The deployment may include verifying the existence of all dependency relationship resources of the resource on the system and transmitting a warning if any of the dependencies of the are unsatisfied. The deployment may also include creating an abstract resource if the abstract resource recorded as a dependency is not found on the system to which the resource is being deployed. The abstract resource may be created based on the dependency relationship definition of the abstract resource. If any dependency relationship is unsatisfied, and deployment can not be completed without the dependency, deployment may be ended.

In another aspect of the invention, the process includes performing a startup and initialization of a resource. In this aspect of the invention, startup and initialization of a first resource may be performed up to inter-component connection, determining whether the resource has any dependency resources, where the resource and its dependency resources forming a group of resources and determining if the dependency resources have been started up. Then, startup of the dependency resources is performed up to inter-component connection if the dependency resources have not been started up. The process further includes inter-component connection the group of resources, proceeding with the startup of a first resource of the group of resources that has not been started up, pausing the startup of the first resource if the first resource is dependent on a second resource of the group of resources that has not completed startup until the second resource has completed startup.

In another aspect of this invention, a process of managing dependencies includes receiving indication of a state change for a first resource, transmitting the indication of the state change of the first resource to a second resource dependent on the first resource, and receiving indication of a state change of the second resource.

These and other objects, features and advantages of the invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

The invention will be described with respect to the accompanying drawings, in which like elements are referenced with like numbers.

FIG. 1 is a block diagram illustrating a simplified view of one embodiment of an architecture for supporting an open programmability environment;

FIG. 2 is a block diagram illustrating a simplified view of one embodiment of a system for managing a component-based system;

FIG. 3 is a block diagram illustrating one embodiment of a configuration of a resource in a system for managing a component-based system;

FIG. 4 is a block diagram illustrating one embodiment of a system for managing a component-based system;

FIG. 5 is a block diagram illustrating one embodiment of an application component in a system for managing a component-based system;

FIG. 6 is a block diagram illustrating one embodiment of a dependency mechanism in accordance with the present invention;

FIG. 7 is a flow diagram illustrating one embodiment of a method of managing dependencies during deployment of resources in a component-based system;

FIG. 8 is a flow diagram illustrating one embodiment a method of managing dependencies during startup of resources in a component based system; and

FIG. 9 is a flow diagram illustrating one embodiment of a method for managing dependencies in a component-based system.

### DETAILED DESCRIPTION OF THE PREFERRED EMBODIMENTS

The invention is related in one regard to the use of a computer system for managing dependencies a component-based system, using computer, network and other resources. According to one embodiment of the invention, the management of dependencies in the component-based system is provided via the computer system in response to the processor executing one or more sequences of one or more instructions contained in main memory.

Such instructions may be read into main memory from another computer-readable medium, such as the storage device. Execution of the sequences of instructions contained in main memory causes the processor to perform the process steps described herein. One or more processors in a multi-processing arrangement may also be employed to execute the sequences of instructions contained in main memory. In alternative embodiments, hard wired circuitry may be used in place of or in combination with software instructions to implement the invention. Thus, embodiments of the invention are not limited to specific combination of hardware circuitry and software.

The term “computer-readable medium” as used herein refers to any medium that participates in providing instructions to the processor for execution. Such a medium may take many forms, including but not limited to non-volatile media, volatile media, and transmission media. Non-volatile media include dynamic memory, such as main memory. Transmission media include coaxial cables, copper wire and fiber optics, including the wires that comprise the bus. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor for execution. For example, the instructions may initially be borne on a magnetic disk of a remote computer. The remote computer can load the instructions into its dynamic memory and send the instructions over a telephone line using a modem. A modem local to the computer system can receive the data on the telephone line and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by main memory may optionally be stored on a storage device as described herein, either before or after execution by the processor.

The computer system also includes a communication interface coupled to the bus. The communication interface provides a two-way data communication coupling to a network link that is connected to a local or other network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links also may be implemented. In any such implementation the, communication interface sends and receives electrical, electromagnetic or optical signals that carry digital data streams representing various types of information.

The network link typically provides data communication through one or more networks to other data devices. For example, the network link may provide a connection through local network to a host computer, server or to other data equipment operated by an Internet Service Provider (ISP) or other entity. The ISP in turn provides data communication services through the world wide packet data communication network, now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), network link, and the communication interface. In the Internet example, a server might transmit a requested code for an application program through the Internet, ISP, local network and communication interface. In accordance with the invention, one such downloaded application provides for operating and maintaining the integration system described herein. The received code may be executed by the processor as it is received, and/or stored in storage device, or other non-volatile storage for later execution. In this manner, the computer system may obtain application code via a carrier wave or other communications.

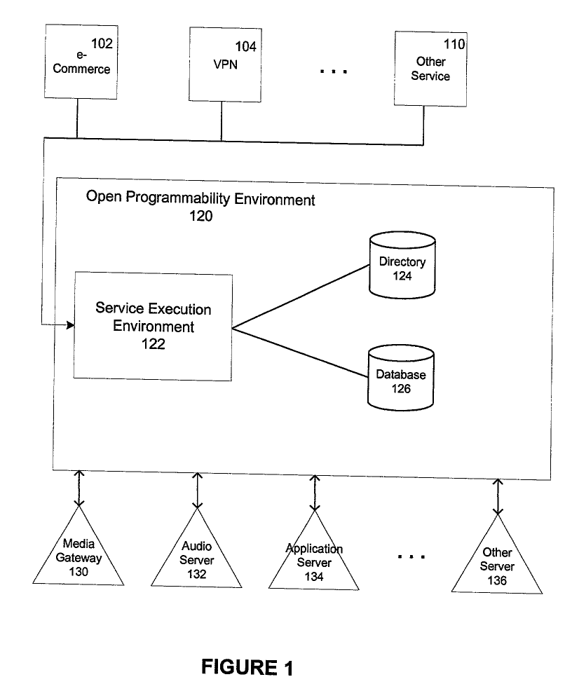

FIG. 1 illustrates an example of an architecture for supporting a system providing an open programmability environment, according to an embodiment of the present invention. An open programmability environment 120 of the present invention provides an environment where, among other things, hardware components do not need to be hardwired to other specific types of components for communication. Instead, various data structures and control logic may be processed in order to establish proper communication with varying and multiple devices. Thus, data of differing types and variations may be received and processed without restructuring or reconfiguring the overall system.

The open programmability environment 120 of the present invention may include hardware, software, communication and other resources. As illustrated in FIG. 1, the open programmability environment 120 may support resources including a service execution environment 122, Directory 124 and Database 126. Other resources may also be included. Generally, a resource may include anything which may be needed for a service to execute successfully. For example, in a telephone network implementation, a resource may include a database, network addresses, switches, and other hardware, software, control logic or other components used to support connections. Other implementations, variations and applications may be used.

A variety of services may execute within the Service Execution Environment of the Open Programmability Environment. These services may include, for example Virtual Private Network (“VPN”) 104, e-Commerce 102, and other services 110, etc. These service may be accessed by a variety of means including web browsers, mobile phones, voice menus, etc.

Back-end processing may occur, for instance, through Media Gateway 130, Audio Server 132, Application Server 134, and other servers 136.

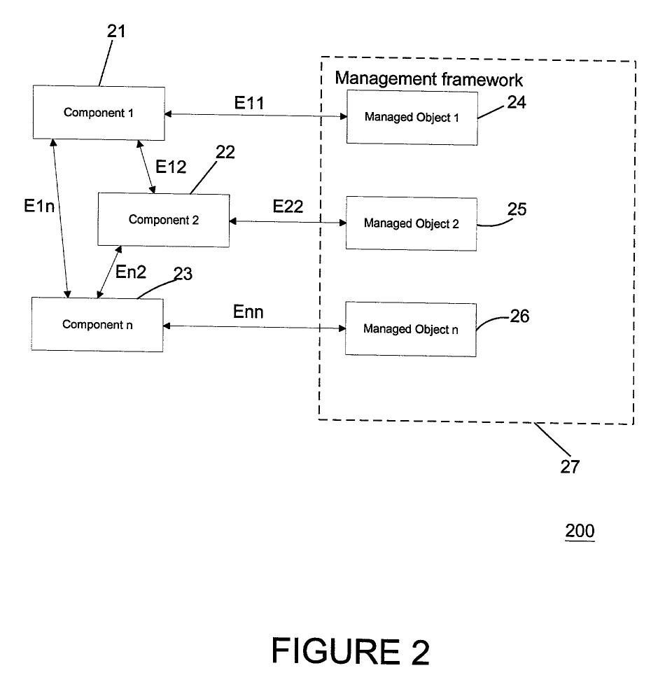

FIG. 2 is a block diagram illustrating a simplified view of one embodiment of a system for managing a component-based system. The system 200 includes components 21-23, management framework 27 including managed objects 24-26.

System 200 illustrates that an application may be representable by one or more managed objects. Each managed object is associated to exactly one resource. Thus, each resource or component 21-23 is associated with one managed object (“MO”) 24-26. Component 1 21 is associated to MO 1 24. Component 2 22 is associated to MO 2 25. Component n 23 is associated to MO n 26. All MOs 24-26 model each component 21-23 using a data model consisting of attributes and events.

Each component 21-23 may communicate with another component 21-23 through a bidirectional set of unidirectional events Exy. Thus, component 1 21 may communicate with component 2 22 and component n 23 through events E12 and E1n. Component 2 22 may communicate with component n 23 through event En2. In addition, a component 21-23 may communicate with its associated MO 24-26 through a set of events E11, E22, Enn. The specific events in the set will depend on the two interconnected components 21-23 or a component 21-23 and its associated MO 24-26.

The set of MOs 24-26 may be contained within management framework 27. The framework 27 may provide a set of access mechanisms such that the managed objects 24-26 may be found and operated on by an external tool.

The common component interface of all the network 100 components 21-23 utilizes an event model as an interconnection mechanism. Each component 21-23 may provide and consume events. All inter-component events have a degree of commonality such that the component interface is programmatically identical. As such, regardless of the event type produced and consumed, any two network 100 components 21-23 may be theoretically joined, although a given component 21-23 may or may not know how to respond to an arbitrary event Exy. The set of events to and from a given component 21-23 is a function of that component, and each component 21-23 interacts with its MO 24-26 through a potentially unique set of events.

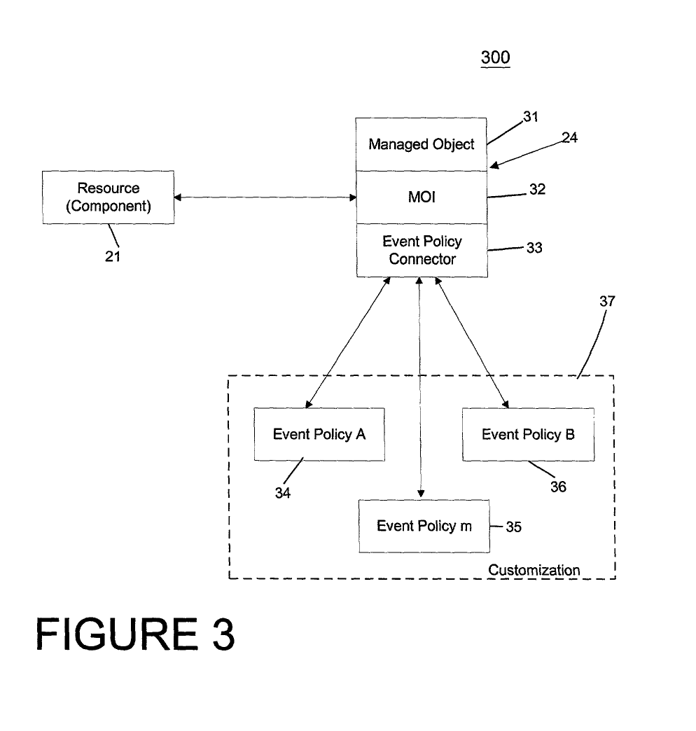

FIG. 3 is a block diagram illustrating one embodiment of a configuration of a resource in a system for managing a component-based system. The system 300 includes a component 21, a MO representation 24, including a managed object view 31, managed object interpreter 32, and event policy connector 33, and a customization tool 37, including event policies 34-36.

Managed object interpreter (“MOI”) 32 may provide functionality to translate component specific events into a common managed object data model possessing state, status and alarm attributes. The MOI 32 may communicate with component 21 to translate events into the view represented by managed object view 31. Through event policy connector 33, an event passed to the MOI 32 may be sent to one or more of event policies 34-36 programmed to respond to the event received. Event policies 34-36 may possess states, status and alarms. Thus, MOI 32 aggregates the event policy information across all event policies 34-36 using an aggregation algorithm.

An event policy 34-36 may behave in a deterministic manner in response to events. An event policy type may be created to suit application requirements. For example, a counter may provide a means to count events, a Frequency Meter may measure the frequency of incoming events for comparison to alarm thresholds, etc. Event policies 34-36 respond to a set of events received by the MOI 32, and may send events to the managed object observer 28 and/or the resource 21 upon a state change. Event policies 34-36 may comprise attributes other than states, status or alarms.

Customization tool 37 may consist of an arbitrary set of event policies 34-36 which may be selected from an event policy library through a configuration mechanism, such as a management editor tool.

In an illustrative example, component 21 may provide socket server function, and may be used in a component-based web server application, such as, for example, application server 3. Thus, component 21 may be managed to provide a state, status and alarm data, as defined by the managed object model.

The socket server 3 may produce events such as Fault Detected Event, for any socket server failures detected and Connection Request Event, for any new socket requests. The socket server 3 may listen and respond to events such as, for example, Go Offline and Go Online. When the socket server 3 hears a Go Offline event, the socket server 3 may close all sessions and not respond to new connection requests. When the socket server 3 hears a Go Online event, the socket server 3 may accept new connection requests.

Event policies that may be associated with the socket server 3 events may include Fault Detected Counter, Connection Request Counter and Administrative State Handler. The Fault Detected Counter may be incremented each time the Fault Detected Event is received by the MOI 32. The Connection Request Counter may be incremented each time a connection request event is received by the MOI 32.

The Administrative State Handler event policy may allow the MOI 32 to choose to lock or unlock the application server 3. As lock or unlock events arrive at MOI 32, this event policy will change states as appropriate.

Through the management editor tool, event policies may be registered to listen for specific events from the component 21 or an external source. Thus, in application server 3, for example, as the system starts, the managed object 24 may be in a locked state. The MO 24 may receive an unlock event. The Administrative State Handler may receive this event and change the state to UNLOCKED. The state change may result in an event reported from this event policy to the MOI 32. The MOI 32, upon receiving the event, may notice that the administrative state is unlocked, and send a Go Online event to the component 21 (application server 3), if no other managed objects are disabled. Thus, application server 3 may start.

In operation, any connections and failures may be counted. The managed object observer 28 may look at the current administrative state and the current counter values at any time. By looking at the counters, users may periodically notice periods of time where faults are rampant. Thus, a customer may disable the application server 3 for a period of time when the fault events are received at an excessive rate.

While the application server 3 is in a disabled state, a critical alarm may be desired to notify the managed object observer 28. A Frequency Meter event policy may be used to provide a critical alarm to notify the managed object observer 28 at the disabled state. The Frequency Meter event policy may be connected to the Fault Detected Event from the component along with Fault Detected Counter event policy.

In operation, the counters may function as before. However, if the frequency of the fault event exceeds a predetermined rate, such as, for example, ten (10) times per second, the Frequency Meter may change to a disabled operational state and produce a critical alarm. As a result, the Frequency Meter may send out an “operational state change,” and “alarm change event” and “log event” to the MOI 32.

Upon receiving the events, the MOI 32 may determine if the operational state is disabled, and the overall alarm level is critical. As a result of the change to the disabled state, the MOI 32 may send a Go Offline event to the component 21, which will terminate operation.

The events, and the log event may be forwarded to an external management tool. When the timer, set for a predetermined amount of time, expires in the frequency meter, the operational state will return to “enabled.” In addition, the alarm may be cleared. The MOI 32 may then send a Go Online event to the component 21.

Thus, a component may be defined in terms of I/O events that may be of interest to the managed objects. As the component 21 is integrated in the system 200, desired event policies may be added. Thus, although the appropriate management behavior in the context of a new application is not known at component design time, the management behavior may be determined at component integration time for a given application.

Management behavior of the component may also be modified through the addition and removal of event policies to suit the requirements of an application without modifying the component code. Thus, management behavior may be customized by selecting from a predefined set of flexible “event policies” which perform appropriate management functions when events are received from a component 21. Thus, it is possible to manage software components rather than hardware devices. The managed objects 24-26 may be queried or operated on by the managed object observer 28. The configuration driven interpretation mechanism greatly reduces the effort required to translate component specific events to the managed object model.

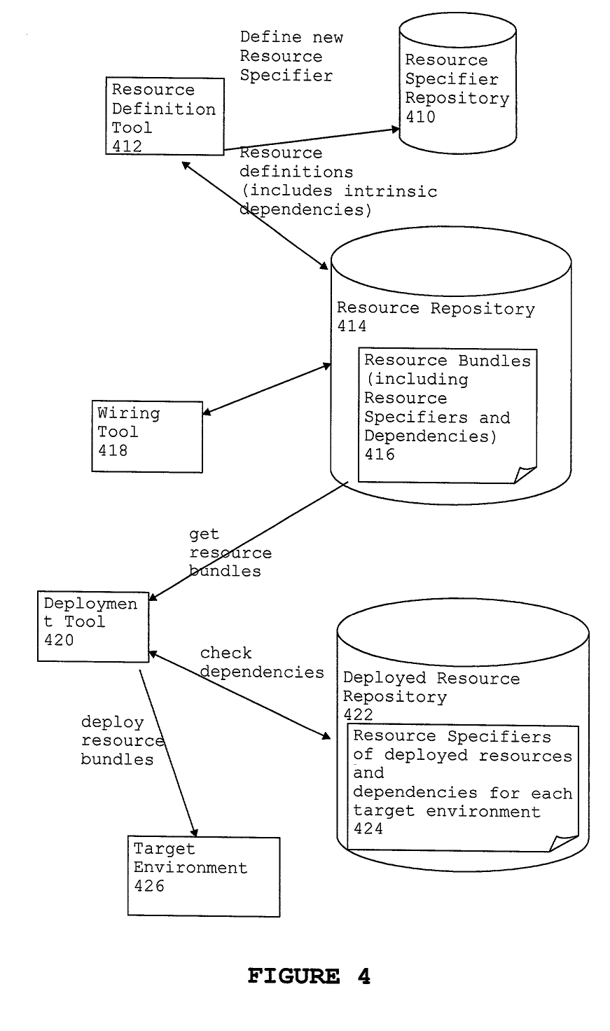

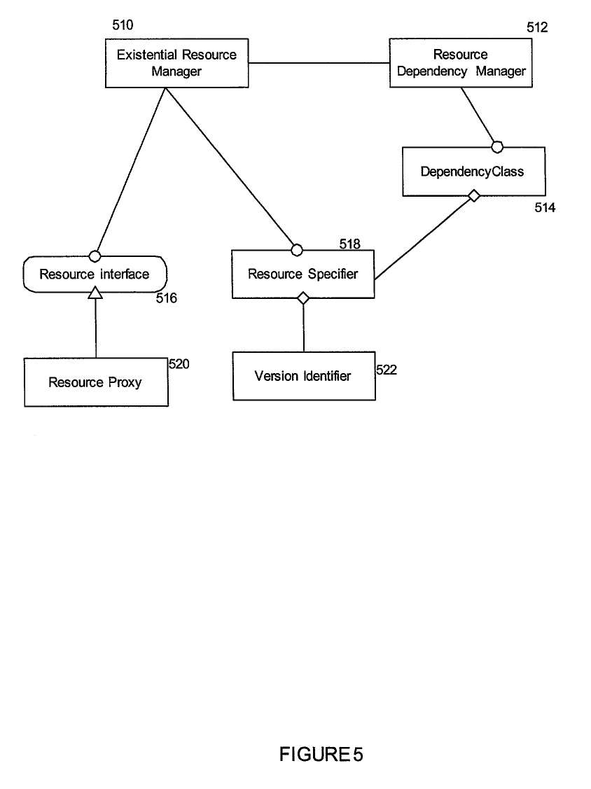

As illustrated in FIG. 4, static resources, for example, may be managed by the resource management system of the present invention.

There may be a variety of Resource Definition Tools, according to an embodiment of the present invention. For example, each different type of resource may be associated with a separate definition tool. Resource Definition Tool 412 may define a new resource specifier and store it in the Resource Specifier Respository 410, verifying that it is unique. There may be a number of resource repositories where the repositories do not need to be physically co-located.

Resource Definition Tool 412 may communicate resource definitions to Resource Repository 414 where resource definitions may include intrinsic dependencies and other relevant information. For example, resource definitions may include dependencies which are intrinsic to the resource. If a service is defined, and that service uses a particular software component (e.g., JavaBean), the definition of the service may explicitly include a dependency on the identified software component. In addition, resource definitions may also include the Resource Specifiers of the defined resources. Other relevant information may also be included.

According to an embodiment of the present invention, Resource Specifier Repository 410 may be centralized so that universal uniqueness of newly defined Resource Specifiers may be guaranteed. The centralization may be realized by delegating management of portions of the Resource Specifier name space to physically separate repositories.

Inter-component connection Tool 418 may be given access to any repository which contains the resources it is accessing. Inter-component connection Tool 418 may read in Resource Bundles 416, which may be stored in Resource Repository 414 and allow relationships to be defined between the resources in the bundles. These wired relationships may constitute extrinsic dependencies between resources. It may generate as output another resource bundle, which may contain these dependencies between the resources which are part of the bundle.

For example, a FreePhone service (800) may generate an event dictating that a phone call should be routed to a particular number, a Local Number Portability (“LNP”) service may accept such an event and translate it to route to a different number. Neither of these services is intrinsically dependent on the other, but by “connecting” these two services together into a bundle (such that they may interwork when the bundle is deployed) and extrinsic dependency is defined between them. This process may be iterative thereby creating larger and larger nested bundles of resources.

Information related to resource bundles from Resource Bundles 416 may be retrieved by Deployment Tool 420. Deployment Tool 420 may deploy one or more resource bundles to a target environment 426 or other destination. At deployment, Deployment Tool 420 may check Deployed Resource Repository 422 for dependencies and update the repository. Repository 422 may track and maintain the Resource Specifiers of resources which have been deployed to each target environment or other destination, the dependencies between all these resources and other relevant information, as shown by 424.

When a resource bundle is deployed, its dependencies may be checked against Deployed Resource Repository 422. If deployment proceeds, then the resource specifiers in the newly deployed bundle and the dependencies of the newly deployed bundle may be added to Deployed Resource Repository 422 for the specific target environment.

Deployment Tool 420 may also allow resources to be removed from a target environment. In this case, the Deployed Resource Repository 422 may be checked to ensure that the dependencies of all remaining resources are still satisfied.

According to an embodiment of the present invention, a resource manager may include various components as illustrated in FIG. 5. Resource manager may comprise Existential Resource Manager 510, Resource Dependency Manager 512, Dependency Class 514, Resource Interface 516, Resource Proxy 520, Resource Specifier 518, and Version Identifier 522. Other components may also be implemented.

Existential Resource Manager (“ERM”) 510 may provide functionality related to keeping track of what resources exist within a given environment or other parameters. Since different resources may exist in different environments, each environment in which resources may exist may have its own instance of the ERM.

Resource Dependency Manager (“RDM”) 512 may be responsible for keeping track of the dependencies between or among resources. Any functionality related to the storing or checking of these dependencies may be provided by RDM 512.

Thus, resource relationships may be altered and managed through the resource manager without having to directly involve the resource.

Resource Specifier 518 may uniquely identify a resource, its version, and other resource characteristics. When an entity wants to identify a dependency on a resource or request a resource, it may do so by using a resource specifier. For example, when the resource manager is requested to check dependencies or retrieve a resource, it may ensure that the resources found are compatible with those required. Thus, a returned resource may be a newer version than the one requested, and its true resource identifier may be an alias of the one requested.

When resource specifiers are aliases for the true specifier of a resource, they may have references to the primary resource specifier. In addition, the resource manager may store references to the resources themselves or to their proxies/managers within the resource specifier.

The Version Identifier 522 may allow the comparison of versions of the same resource. It may be implemented as a class so that different version numbering schemes may be implemented as subclasses if required.

A Resource Interface 516 may be a utility interface which may be implemented by one or more resource classes.

A Resource Proxy 520 may be a class that provides a concrete implementation of the resource identifier. In addition, it may provide a means of retrieving an associated resource. This may be used by RDM 512 to represent resources. To optimize runtime resource allocation, subclasses of Resource Proxy 520 may be implemented which keep references to either resource object directly, or to resource pool managers which control the allocation of particular types of resources.

Dependency Class 514 may be used to represent a dependency between two or more resources. Other information may also be provided. Generally, a resource may be dependent on another resource or other entity. For example, there may be different types of dependencies an entity may have on a resource. For example, an entity may contain a resource. Also, an entity may use a resource without containing it. Generally, an entity may not exist without a resource which it contains. If an entity uses (but does not contain) a resource, it may passively exist without the resource, but may not operate (or execute) without the resource.

One aspect of static resource management may involve keeping track of the resources which exist, their versions and other characteristics. The present invention provides a data management interface that may store identifiers and versions of each entity which exists in a given context, as well as other information. A consistent resource identification and versioning strategy may be applied across resource types.

If an entity uses a specific resource, then it is generally considered to be dependent upon that resource. The action of specifying that the entity uses the resource may define the dependency. For example, when a service designer places a bean into a service, that act may implicitly establish the fact that the service depends on the bean. In addition, other resource dependencies may be completely implicit. Also, resource dependencies may require explicit designation by a service designer or other entity.

Most resources which may be deployed to a network have dependencies on either hardware or software which may be specific to a certain node type in the network. The present invention presents a method of defining a resource which represents the required capability and defining the dependency on that resource. Thus, this approach has the benefit of identifying and recording true dependencies on functionality rather than artificially defining sets of functionality as belonging to different nodes. This makes deployment independent of an arbitrary “node type” concept and enables the splitting and combining of nodal functions in the network, without modification to either the deployment tool, or the deployed resources.

For example, if a service requires a communication channel to a remote node, and that communication channel goes down, then the service is also down. Since the communication channel does not know what is dependent upon it, there is no way for the communication channel to give explicit notification to its dependents. Thus, the service will not know the communication channel is down until the service tries to use it. The present invention provides a method and system for communicating explicit indication of the consequences of any given outage of performance degradation. This may be achieved by propagating state change information. In addition, it may be useful to retrieve direct indication of the root cause of any service problems. Thus, the present invention provides a method and system for connecting (or associating) the MOIs of different entities together via the dependency relationships stored in the resource management infrastructure of the present invention.

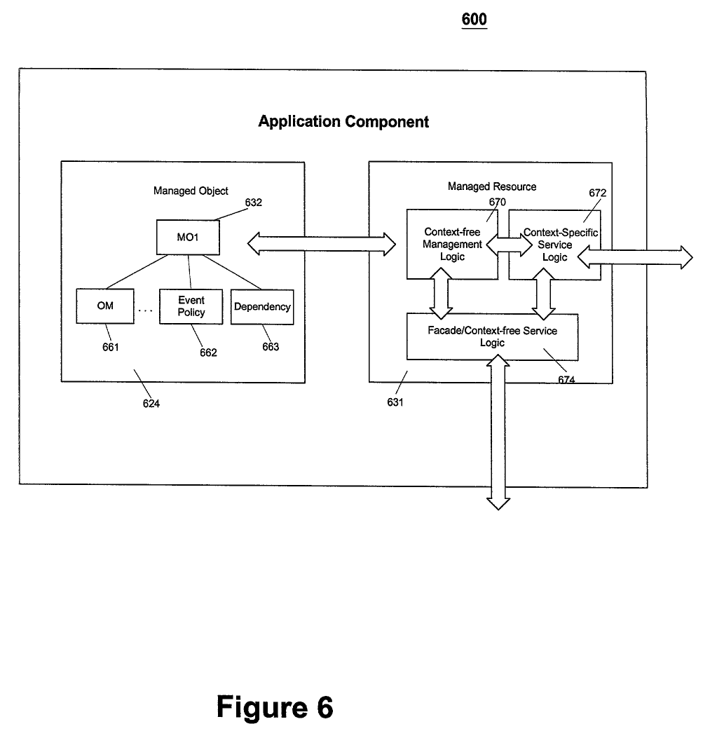

FIG. 6 is a block diagram illustrating one embodiment of an application component in a system for managing a component-based system 100. An application component 600 is a unit of encapsulation that contains logic that may be executed at various parts of system 100. The application component is the fundamental system building block of system 100. A service or application may be composed of one or more application components 600. Application component includes managed object 624 and managed resource 631. The managed resource 631 has three main parts, including a context free management logic 670, a context-specific service logic 672 and a facade/context-free service logic 674. Each part 670, 672, 674 communicates externally or to other parts via events. Events may enter and/or exit the logic of various parts of a managed resource through event portals. A collection of event portals (not shown) may present the interface for the various parts of a managed resource.

All logic of an application component may be contained within the facade 674. The facade 674 contains context-free service logic. Context-free service logic is always executed when an event first enters an application component 600. The service logic is not executed within any context envelope.

A context envelope is a single-threaded entity. Any resource that executes within a context envelope executes in the same thread. There may be more than one context envelope active in the system at any given time, each representing an active transaction.

Facade 674 executes in a multi-threaded fashion, and has no state associated with of any single transaction. As part of executing its logic, the facade 674 may decide that execution should continue in other parts of the managed resource, such as context-specific service logic. Context-specific service logic 672 may contain state associated with an individual transaction. The context-specific service logic 672 may contain a collection of context event portals that is a subset of a collection of facade event portals. Each context-specific service logic may execute within a context envelope.

Each bean within the context-free management logic 670 may act as a proxy to invoke specific functions within the managed object 624. Context-free management logic 670 may execute as a single-threaded entity.

Managed object 624 include MOI 632 and management components 661-663. Each management component 661-663 within the managed object 624 is responsible for a specific management behavior. For example, OM 661 is responsible for monitoring a specific operational measurement, event policy 662 is an arbitrarily complex management state machine which may act on specific events, a dependency event policy 663 may be responsible for reporting pre-aggregated states of another managed object 624 upon which it depends. The MOI 632 is responsible for aggregating the states, status and alarms from all management components 661-663 inside a managed object 624. The MOI 632 may then report the information via management events to the management event concentrator 440. Dependency relationships may be established between any two managed objects 624.

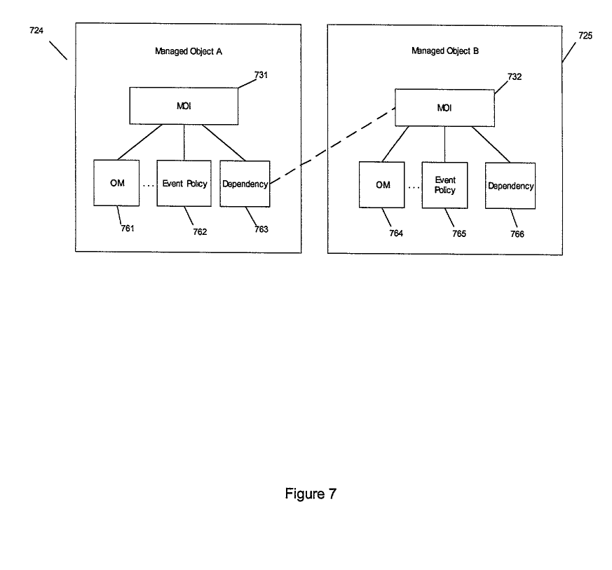

FIG. 7 is a block diagram of one embodiment of a dependency mechanism in accordance with the present invention. Managed object A 724 is dependent on managed object B 725. Managed objects A 724 and B 725 include MOIs 731, 732, and operations measurement management component 761, 764, and event policy management component 762, 765, and a dependency event policy management component 763, 766. Since managed object A 724 is dependent on managed object B 725, the dependency management component 763 of managed object A 724 has an association with managed object interpreter 732 of managed object B 725.

A dependency relationship may be established between any two managed objects 724, 725. When one managed object 724 is dependent on another managed object 725, the second managed object's 725 state may effect the first managed object's 724 state.

Dependency 763 is responsible for observing events from managed object 725, and interpretting their significance to managed object 724. There may be different types of dependency relationships. The type of dependency relationship may determine how Dependency event policy 763 behaves when it observes a state change in managed object 725 via its MOI 732. Managed object 724 may have a critical dependency on a second managed object 725. When managed object 725 becomes unavailable, managed object 724 may also become unavailable via the dependency mechanism 763. That is, dependency 763 will interpret the unavailability of managed object 725 to mean that managed object 724 should become unavailable. When a provider managed object 725 goes into an unavailable state, the user managed object 724 may also go into an unavailable state if there is a critical dependency. If there is a non-critical dependency, when a provider managed object 725 goes into an unavailable state, the dependency event policy 763 may cause the user managed object 724 to go into a degraded state.

Other types of dependencies may exist, and the logic of a Dependency event policy may be arbitrarily complex to reflect the nature of the dependency. For example, a managed object 724 may depend on a group of other managed objects, such that if ‘n’ out of ‘m’ of them are available, then there is no problem. However, if fewer than ‘n’ are available, then the dependent managed object may be degraded, etc. Furthermore, new types of Dependency event policies may be created and added as described in the related patent application entitled “System and Method for Managing a Component-Based System,” U.S. patent application Ser. No.______.

There may be different types of dependency relationship, such as, for example, the critical relationship described above. If the dependency is not critical, managed object A 724 may go into a degraded state instead of a disabled state.

Resource management may be classified as static or dynamic. Static resource management may encompass the management of resources which take place up to and including deployment of the resources to the network. Dynamic resource management may encompass the management of resources after deployment to the network.

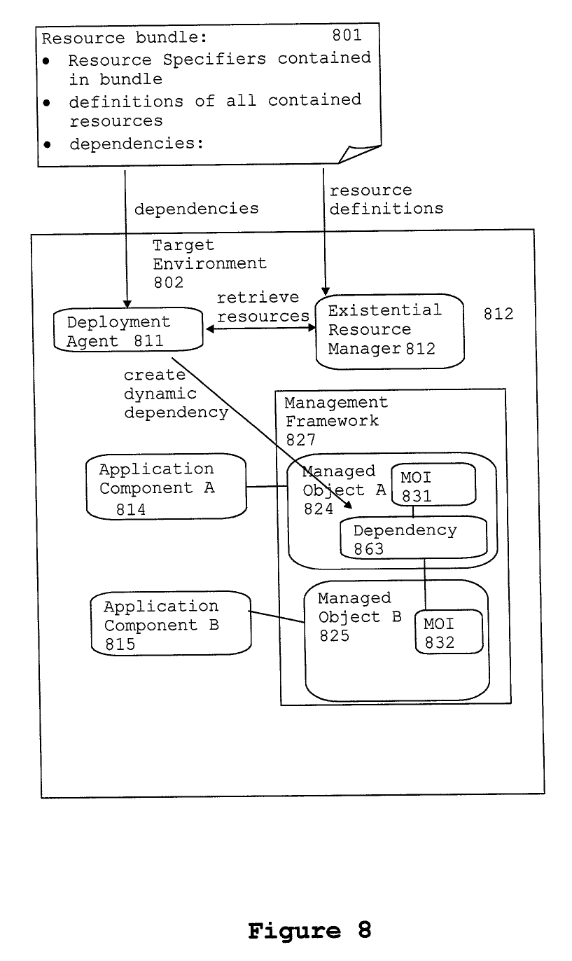

FIG. 8 is a relational diagram illustrating one embodiment of deployment mechanism. Deployment mechanism 800 includes a Resource Bundle 801 and a Target Environment 802.

Resource Bundle 801 may include Resource Specifiers, definitions of all contained resources, and dependencies. The dependencies may include dependency type for each dependency and a Resource Specifier for each dependency resource.

Target Environment 802 may include Deployment Agent 811, Existential Resource Manager 812, Application Component A 814, Application Component B 815, and Management Framework 827. Management Framework 827 may include Managed Object A 824, corresponding to Application Component A 814, and Managed Object B 825, corresponding to Application Component B 815. Managed Object A 824 may include MOI 831 and Managed Object B may include MOI 832.

Deployment Agent 811 may read in dependencies from Resource bundle 801. Deployment Agent 811 may then create a manifestation of these dependencies in the Management Framework 827. Deployment Agent 811 may instantiate the appropriate type of Dependency Event Policy 863 based on the dependency type specified in Resource bundle 801, and connect this Dependency Event Policy 863 to the MOI 831 of the dependent managed object 824, and the MOI of the dependency 825.

Application Component A 814 may be dependent on Application Component B 815. Thus, Dependency event policy 863 of Managed Object A

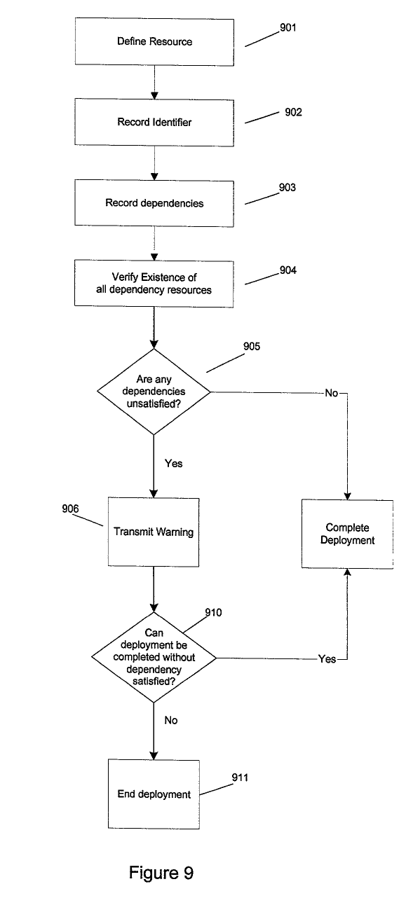

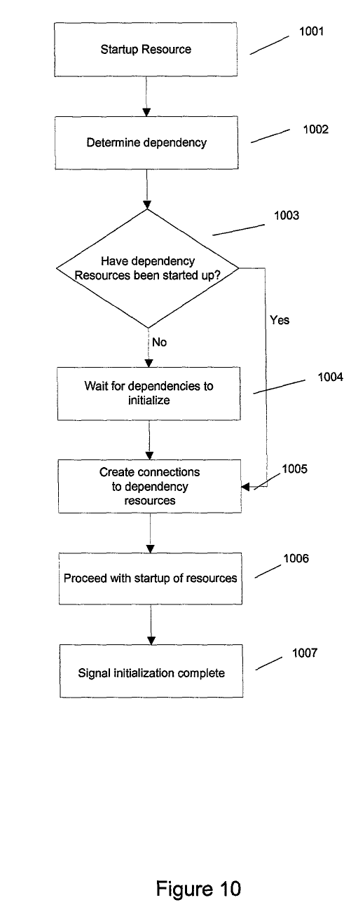

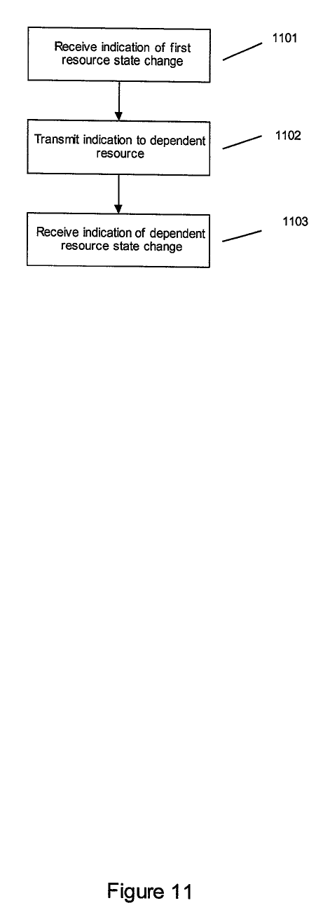

FIG. 9 is a flow diagram illustrating one embodiment of a method of dependency management during deployment of a resource in a component-based system.

At step 901, a resource 824 may be defined. At step 902 an identifier for the resource 824 may be recorded. At step 903, dependencies 863 of the resource may be recorded. At step 904, the existence on the network of the dependency resources may verified. At step 905, a managing entity may determine if any dependencies of the resource 824 are unsatisfied. If any dependencies are unsatisfied, at step 906, the managing entity may transmit a warning and proceed to step 907. If the dependencies are satisfied, the process may proceed to step 909.

At step 907, abstract resources that have not been found on the network may be created. At step 908, the managing entity may determine whether any dependencies are still unsatisfied. At step 909, if the dependencies are all satisfied, deployment may be completed. If any dependencies are unsatisfied, deployment tool 420 may determine whether deployment may be completed without the dependencies satisfied at step 910. This may depend on the type of dependency, and input from the user of the Deployment Tool 420 (who may choose to deploy even though a critical dependency is unsatisfied, i.e. absent).

If the deployment may be completed without the dependencies satisfied, the deployment may be completed at step 909. If the deployment may not be completed without the dependencies satisfied, the deployment is ended at step 911.

At step 901, a resource is defined. Defining a resource may include storing a definition of a resource in a tool to be accessed by a service creation environment (“SCE”), a deployment tool, or a service logic execution environment (“SLEE”).

At step 902, an identifier for the resource may be recorded. The identifier for the resource may include a resource identification (“resourceID”), a type identification (“typeID”), and a version identification (“versionID”). Each resource may have an identifier which may be used to uniquely distinguish it from all other resources. Within a given SCE, a unique identifier may be allocated for a given resource.

At step 903, dependencies of the resource defined may be recorded. Recording dependency information for the resource may include recording associations between the resource identifier and the identifiers of the dependency relationship resources. The dependency information may be automatically recorded or manually recorded by software coding. Recording the resource dependency definitions may include defining the Resource Specifiers of the dependencies for the resource and/or identifying the type of dependency for each dependency resource. Identifying the type of dependency may include identifying a dependency as one of (1) a resource that is “contained by” the service or application or other entity, and (2) a resource that is “used” by the service or application. If a resource is contained by a service or application, it may be defined to also be used by the service or application. If a dependency resource is of “used by” dependency type, the resource may be deployed without satisfying the dependency relationship. The rules for identifying the dependency type may include: (1) if entity A uses resource B and resource B uses resource C, then entity A contains resource C; (2) if entity A contains resource B and resource B contains resource C, then A contains C; (3) if A uses B and B contains C, then A uses C; and (4) if A contains B and B uses C, then A uses C.

Other types of dependencies may be defined which define specific relationships between resources. The type of dependency between two resources will define the desired static and dynamic dependency management behavior.

If an entity uses a specific resource, then it is dependent upon that resource. The action of specifying that the entity uses the resource may define the dependency. For example, when a service designer places a bean into a service, that act may implicitly establish the fact that the service depends on the beam. Whenever possible, the SCE may record the definition of resource dependencies automatically or implicitly, without the service designer having to explicitly design them. This information may then be passed on to the part of the management framework 827 which manages resource dependencies.

Dependencies between non-service associated entities may require explicit definition on the part of designers. For example, if a particular piece of software requires a communication channel, the designer of that software may need to write some explicit code which establishes that dependency.

It may be possible to automatically determine for any given entity, whether or not its dependencies are satisfied in a give context. A single static resource dependency manager (“SRDM”) may be used to provide this capability. The SRDM may be available from anywhere in the management framework 827. When resources become available in a given context, they may be registered with the SRDM. Dependency relationships may be defined in a consistent way throughout the management framework 827 so that the SRDM may verify for any given entity in any given context whether its static resource dependencies are satisfied.

For example, when a preexisting service definition is loaded onto the SCE, the SCE may be able to verify that all beans which constitute the service are present. Also, when a service is deployed to a management framework 827, the deployment tool 420 may be able to verify that all of the resources required by the service are present either in the target nodes or in the deployment bundle.

Many resources which may be deployed to a network may have dependencies on either hardware or software which may be specific to a certain node type in the network. This may be handled by defining a resource which represents the required capability, and defining the dependency on that resource. For example, since some services may require a SLEE, there may a SLEE resource defined which is known by the deployment tool 420 to exist on certain nodes. Thus, when the deployment tool 420 attempts to a deploy a service to a certain node, it is known whether that node supports the SLEE capability required by the service. Since the SLEE software itself may be deployed using the deployment tool 420, the location and the network of the software is known to the deployment tool 420. This allows identifying and recording true dependencies on functionalities rather than artificially defining sets of functionalities belonging to different nodes. This allows deployment independent of an arbitrary “node type” concept, and enables splitting and combining of nodal functions in the network, without modification to either the deployment tool 420 or the deployed resources 814, 815.

Deployable packages may contain two types of information for the resource management infrastructure . One type of information may be the resource specifier and version of every resource contained in the package, including any alias resource specifiers. A second type of information may include the specifier and version of every resource on which the package has a dependency, along with the definition of the type of the dependency, and resource specifier of the dependency entity. The deployment tool 420 incorporates the Resource Dependency Manager 512 and Existential Resource Manager 510, which it uses in conjunction with the Deployed Resource Repository 422 and the resource bundle 416 being deployed to insure that all resource dependencies are satisfied. In the event that the deployment is impossible because one or more dependencies are not qualified, this information may allow a complete list of unsatisfied dependencies to be provided.

At step 904, the existence of all dependency resources on the network in which the resource is being deployed may be verified. At step 905, a determination is made of whether any dependencies are unsatisfied. If any dependencies are unsatisfied, a warning may be transmitted to the deployment processor, at step 906. The process may then proceed to step 907.

If the dependencies are all satisfied, the process may proceed to step 909. At step 909, the deployment may be completed.

If any dependencies are unsatisfied, then the deployment tool 420 determines whether deployment may be completed without the dependencies satisfied, at step 910. If a package may be deployed in spite of an unsatisfied dependency, then the deployment may be allowed. If this occurs, the managed objects 824, 825 in the deployed package may appear disabled in the management framework 827. Each individual resource dependency may identify whether deployment may proceed if it is not satisfied.

A deployable package may contain a variety of heterogeneous entities. On deployment, each type of entity may be of interest to a different part of the system. Thus, entities within the package may be grouped according to their type, so they may be selectively delivered to different destinations.

If the deployment may be completed without dependencies satisfied, the deployment may be completed at step 909. If the deployment may not be completed without all the dependencies satisfied, at step 911, the deployment may be ended.

Once resources have been deployed to the network, dynamic resource management may begin. Since there is no way for a manager layer to implicitly know the dependencies between resources and the system, the resource management infrastructure may play a part in dynamic resource management.

FIG. 10 is a flow diagram illustrating one embodiment a method of managing dependencies during startup of resources in a component based system. Each resource will follow this sequence of steps. The execution of these steps for each resource may happen in parallel, or in an arbitrary order. At step 1001, a resource may be started up and/or initiated. At step 1002, dependencies of the resource may be determined. At step 1004, the resource will wait for its dependency resources to complete initialization. At step 1005, connections to dependency resources are established by retrieving these resources from the ERM. At step 1006, start up of the resource may proceed. At step 1007, the startup of this resource is complete, and other resources which depend upon it may establish connections to it.

Start-up of a first resource 815 may be performed up to inter-component connection. An indication may then be received from the resource that its internal resources have been successfully allocated and the resource is waiting for intercomponent connections.

At step 1002, it may be determined whether the resource 815 being started up has any dependency resources. This determination may be made using dependency information. At step 1003, a determination of whether the dependency resources have been started up may be made. If the dependency resources have been started up, the process may proceed to step 1005.

If the dependency resources have not been started up, start up may be performed on the dependency resources. The first resource may be placed on a ready-for-connecting list until the dependency resources are ready for inter-component connection.

At step 1005, inter-component connection may be performed, that is, the dependent resource may retrieve connections to its dependencies. An indication may be received from each of the dependency resources that it has completed startup and is waiting for inter-component connections. At step 1006, the dependent resource now has all of its dependency resources, and it may proceed with start up. Once it has started up it will signal completion of its initialization, so that resources dependent upon it may proceed to step 1005 of their own initialization.

The management system may proceed with start up of a resource first, such as, for example, managed object A 824. The resource 824 may arrive at a “waiting for dependents” stage 1004 and realize that it is dependent on the first resource, such as, for example, managed object B 825. At step 1007, the resource may wait at the waiting for dependents stage until the first resource 825 has completed its start-up.

The management system may continue with starting up the first resource 825. If the first resource 825 is not dependent on any other resource, the first resource 825 may complete its start up sequence. The system may then go back to finish the dependency resource's 824 start-up since the resource 825, on which dependency resource 824 is dependent, has completed its start up.

As resources initialize as part of a start-up sequence, they signal readiness to their MOIs 831, which propagate this information to the MOIs 832 of the dependent resources. This causes the dependent MOIs 832 to indicate to their own MOIs 831 to start up. Thus, a correctly sequenced start up of all resources is performed in optimal time. Similarly, management state information related to failures, lock or shut down requests, etc. may be propagated appropriately along these associations. Note that if a resource fails to complete its startup sequence due to some failure, its dependents will also fail to start-up. This is the correct behavior.

FIG. 11 is a flow diagram illustrating one embodiment of a method for managing dependencies in a component-based system. At step 1101, an indication of a first resource 825 state change may be received. At step 1102, the indication of the first resource 825 state change may be transmitted to a dependent resource 824 of the first resource 825. At step 1103, an indication of a state change by the dependent resource 824 may be received.

At step 1101, indication may be received from a first resource that a state change has occurred for the first resource 825. Receiving indication of the state change may include receiving an indication of the state change from a managed object interpreter 832 of the first resource. The identification information for the dependent resource may be received along with the state change information from the first resource.

At step 1102, an indication of the state change in the first resource 825 may be transmitted to a dependent resource 824 of the first resource. Transmitting the indication to the dependent resource 824 may include transmitting the indication of the state change to a managed object interpreter 831 of the dependent resource.

At step 1103, an indication of a state change in the dependent resource 824 may be received. Receiving the indication of the state change of the dependent resource 824 may include receiving the indication of the state change from the managed object interpreter 831 of the dependent resource 824.

The resource dependency information provided to the management framework 827 by the deployment tool may be used to dynamically manage resources. Individual entities which may be dynamically managed, such as managed objects, may have corresponding entities with which the management framework 827 communicates, such as MOIs.

An individual managed object may communicate with its MOI to insure that the management framework 827 is aware of any state changes which occur spontaneously. Conversely, if any state changes on the managed object are requested through the management framework 827, the MOI may inform the managed object of the desired state change information.

When an entity has a dependency on a particular resource, there may be an implicit relationship between their states. An explicit indication of the consequences of any given outage or performance degradation may be achieved by propagating state change information upward through a dependency graph. Also, a direct indication of the root cause of any service problems may be found by following the dependency graph downward from the mall functioning service, following the dependency links which are not in a normally functioning state. This functionality may be achieved by tying MOIs of different entities together through dependency event policies 663, 763, 766 which mirror the dependencies 514 stored in the resource management infrastructure.

A special case in dynamic resource management may be the management of resource pools. When a set of homogenous entities are used interchangeably on a dynamic basis, they may be typically placed into a pool and allocated to dependent objects as needed. In this case, there may be no defined permanent dependency relationship between the pooled entity and its dependent object. Thus, a relationship may be created between the dependent object and a pool manager. The pool manager may behave as the proxy for the pooled entities, handling dependency relationships on behalf of the pooled entities.

Some very low level resources such as memory, processing power or threads may always be managed dynamically. This type of resource may be managed by the operating system, Java™ virtual machine or low-level parts of the system. This may be an extreme case of the pool situation discussed above. Thus, an extension of the pool approach may be used to manage the relationships of these low-level resources, and use a low-level part of the system to act as a proxy for these resources. If the system experiences a problem with these resources, such as, for example, gets close to maximum CPU occupancy or dangerously close to out of memory, the proxy object may notify its MOIs. The dependency relationships between the higher level entities and this proxy may tell the system to notify the higher level M beans of the problem. These higher level MOIs may in turn provide appropriate instructions to their managed objects.

Other embodiments, uses and advantages of the invention will be apparent to those skilled in the art from consideration of the specification and practice of the invention disclosed herein. The specification should be considered exemplary only, and the scope of the invention is accordingly intended to be limited only to the following claims.

What is claimed is:

1. A method of dependency management in a component-based system comprising:
defining a resource;
recording an identifier for the resource;
recording resource dependency relationships definitions for the resource;
deploying the resource and the resource dependency relationships of the resource to a system including
verifying the existence of all dependency relationship resources of the resource on the system,
transmitting a warning if any of the dependencies of the are unsatisfied, creating an abstract resource based on a dependency relationship definition of the abstract resource if the abstract resource is not found on the system, and
ending deployment if any dependency relationship is unsatisfied and deployment can not be completed without dependency.

2. The method of claim 1 wherein defining a resource comprises storing a definition of a resource in a tool to be accessed by a service creation environment (“SCE”), a deployment tool and a service logic execution environment (“SLEE”).

3. The method of claim 1 wherein recording an identifier to a resource comprises recording an identifier including resource identification, type identification and version.

4. The method of claim 3 wherein recording an identifier further comprises recording an identifier including scope of the resource.

5. The method of claim 1 wherein recording dependency information comprises recording associations between the resource identifier and resource identifiers for the dependency relationship resources.

6. The method of claim 1 wherein recording dependency information comprises automatically recording dependency information.

7. The method of claim 1 wherein recording dependency information comprises manually recording dependency information through one of: software coding and configuration.

8. The method of claim 1 wherein recording resource dependency definitions comprises defining dependencies for the resource.

9. The method of claim 1 wherein recording resource dependency definitions comprises identifying type of dependency for each dependency resource.

10. The method of claim 9 wherein identifying the type of dependency comprises identifying the dependency as one of a resource that is contained by an entity and a resource that is used by the entity, wherein a resource that is contained by the entity is also used by the entity.

11. The method of claim 10 wherein if a resource can be deployed without satisfying a dependency relationship if the dependency resource is a uses type dependency.

12. The method of claim 10 wherein identifying the dependency type comprises identifying the dependency type according to the rules:
if entity A uses resource B and resource B uses resource C, then A contains C,
if A contains B and B contains C, then A contains C,
if A uses B and B contains C, then A uses C, and
if A contains B and B uses C, then A uses C.

13. The method of claim 1 wherein deploying the resource comprises using a deployment tool to deploy the resource wherein the deployment tool transmits information regarding dependency relationships to a resource management infrastructure.

14. The method of claim 1 wherein recording resource dependency relationships definitions for the resource comprises recording dependency relationships to at least one resource pool, the resource pool including a set of homogenous resources used interchangeably on a dynamic basis and allocated to dependent objects as needed.

15. The method of claim 1 further comprising creating a relationship between the resource and a resource pool manager if the resource will be used interchangeably with other resources in a resource pool, wherein the resource pool manager acts as a proxy for the pooled resources and handles dependency relationships on behalf of the pooled resources.

16. A system for dependency management in a component-based system comprising:
means for defining a resource;
means for recording an identifier for the resource;
means for recording resource dependency relationships definitions for the resource;
means for deploying the resource and the resource dependency relationships of the resource to a system including
means for verifying the existence of all dependency relationship resources of the resource on the system,
means for transmitting a warning if any of the dependencies of the are unsatisfied,
means for creating an abstract resource based on a dependency relationship definition of the abstract resource if the abstract resource is not found on the system, and
means for ending deployment if any dependency relationship is unsatisfied and deployment can not be completed without dependency.

17. The system of claim 16 wherein the means for defining a resource comprises means for storing a definition of a resource in a tool to be accessed by a service creation environment (“SCE”), a deployment tool and a service logic execution environment (“SLEE”).

18. The system of claim 16 wherein the means for recording an identifier to a resource comprises means for recording an identifier including resource identification, type identification and version.

19. The system of claim 18 wherein the means for recording an identifier further comprises means for recording an identifier including scope of the resource.

20. The system of claim 16 wherein the means for recording dependency information comprises means for recording associations between the resource identifier and resource identifiers for the dependency relationship resources.

21. The system of claim 16 wherein the means for recording dependency information comprises means for automatically recording dependency information.

22. The system of claim 16 wherein the means for recording dependency information comprises means for manually recording dependency information through one of: software coding and configuration.

23. The system of claim 16 wherein the means for recording resource dependency definitions comprises means for defining dependencies for the resource.

24. The system of claim 16 wherein the means for recording resource dependency definitions comprises means for identifying type of dependency for each dependency resource.

25. The system of claim 24 wherein the means for identifying the type of dependency comprises means for identifying the dependency as one of a resource that is contained by an entity and a resource that is used by the entity, wherein a resource that is contained by the entity is also used by the entity.

26. The system of claim 25 wherein a resource can be deployed without satisfying a dependency relationship if the dependency resource is a uses type dependency.

27. The system of claim 25 wherein the means for identifying the dependency type comprises means for identifying the dependency type according to the rules:
if entity A uses resource B and resource B uses resource C, then A contains C,
if A contains B and B contains C, then A contains C,
if A uses B and B contains C, then A uses C, and
if A contains B and B uses C, then A uses C.

28. The system of claim 16 wherein the means for deploying the resource comprises means for using a deployment tool to deploy the resource wherein the deployment tool transmits information regarding dependency relationships to a resource management infrastructure.

29. The system of claim 16 wherein the means for recording resource dependency relationships definitions for the resource comprises means for recording dependency relationships to at least one resource pool, the resource pool including a set of homogenous resources used interchangeably on a dynamic basis and allocated to dependent objects as needed.

30. The system of claim 16 further comprising means for creating a relationship between the resource and a resource pool manager if the resource will be used interchangeably with other resources in a resource pool, wherein the resource pool manager acts as a proxy for the pooled resources and handles dependency relationships on behalf of the pooled resources.

31. A method of managing dependencies in a component-based system comprising:
performing at least one of a startup and an initialization of a resource up to inter-component connection;
determining if the resource has any dependency resources, the resource and its dependency resources forming a group of resources;
waiting for dependency resources to complete initialization;
establishing connections to dependency resources;
proceeding with the at least one of startup and initialization; and
establishing connections to the resource from the dependency resources.

32. The method of claim 31 further comprising:
receiving indication from the resource that its internal resources have been successfully allocated and that the resource is waiting for connection;
requesting connection information from an inter-component connection manager; and
receiving inter-component connection information from the inter-component connection manager.

33. The method of claim 31 wherein determining if the resource has any dependency resource comprises determining dependency inter-component connection information from inter-component connection information received from an inter-component connection manager.

34. The method of claim 31 wherein inter-component connection the resources comprises
placing the resource on a ready for inter-component connection list until the dependency resources have been started;
receiving indication from the dependency resource that its internal resources have been successfully allocated and that the dependency resource is waiting for inter-component connection;
requesting inter-component connection information from a inter-component connection manager; and
traversing all entries of inter-component connection information.

35. The method of claim 31 wherein performing startup of the dependency resources comprises requesting a resource pool manager to assign a dependency resource from the resource pool.

36. A system for managing dependencies in a component-based system comprising:
means for performing at least one of a startup and an initialization of a resource up to inter-component connection;
means for determining if the resource has any dependency resources, the resource and its dependency resources forming a group of resources;
means for waiting for dependency resources to complete initialization;
means for establishing connections to dependency resources;
means for proceeding with the at least one of startup and initialization; and
means for establishing connections to the resource from the dependency resources.

37. The system of claim 36 further comprising:
means for receiving indication from the resource that its internal resources have been successfully allocated and that the resource is waiting for inter-component connections;
means for requesting inter-component connection information from a inter-component connection manager; and
means for receiving inter-component connection information from the inter-component connection manager.

38. The system of claim 36 wherein the means for determining if the resource has any dependency resource comprises means for determining dependency inter-component connection information from inter-component connection information received from an inter-component connection manager.

39. The system of claim 36 wherein the means for performing inter-component connection on the resources comprises
means for placing the resource on a ready for inter-component connection list until the dependency resources have been started;
means for receiving indication from the dependency resource that its internal resources have been successfully allocated and that the dependency resource is waiting for inter-component connections;
means for requesting inter-component connection information from a inter-component connection manager; and
means for traversing all entries of inter-component connection information.

40. The system of claim 36 wherein the means for performing startup of the dependency resources comprises means for requesting a resource pool manager to assign a dependency resource from the resource pool.

41. A method of managing dependencies in a component-based system comprising:
receiving indication of a state change for a first resource;
transmitting the indication of the state change of the first resource to a second resource dependent on the first resource;
receiving indication of a state change of the second resource.

42. The method of claim 41 wherein receiving indication of the state change of the first resource comprises receiving indication of the state change from a managed object view of the first resource, transmitting the indication of state change to the second resource comprises transmitting the indication to a managed object view of the second resource and receiving indication of the state change of the second resource comprises receiving the indication of state change from the managed object view of the second resource.

43. A system for managing dependencies in a component-based system comprising:
means for receiving indication of a state change for a first resource;
means for transmitting the indication of the state change of the first resource to a second resource dependent on the first resource;
means for receiving indication of a state change of the second resource.

44. The system of claim 43 wherein the means for receiving indication of the state change of the first resource comprises means for receiving indication of the state change from a managed object view of the first resource, the means for transmitting the indication of state change to the second resource comprises means for transmitting the indication to a managed object view of the second resource and the means for receiving indication of the state change of the second resource comprises means for receiving the indication of state change from the managed object view of the second resource.

45. A computer readable medium, the computer readable medium storing computer readable code executable to perform a method for managing a component-based system comprising:
defining a resource;
recording an identifier for the resource;
recording resource dependency relationships definitions for the resource;
deploying the resource and the resource dependency relationships of the resource to a system including
verifying the existence of all dependency relationship resources of the resource on the system,
transmitting a warning if any of the dependencies of the are unsatisfied, creating an abstract resource based on a dependency relationship definition of the abstract resource if the abstract resource is not found on the system, and
ending deployment if any dependency relationship is unsatisfied and deployment can not be completed without dependency.

46. A computer readable medium, the computer readable medium storing computer readable code executable to perform a method for managing a component-based system comprising:
performing at least one of a startup and an initialization of a resource up to inter-component connection;
determining if the resource has any dependency resources, the resource and its dependency resources forming a group of resources;
waiting for dependency resources to complete initialization;
establishing connections to dependency resources;
proceeding with the at least one of startup and initialization; and
establishing connections to the resource from the dependency resources.

47. A computer readable medium, the computer readable medium storing computer readable code executable to perform a method for managing a component-based system comprising:
receiving indication of a state change for a first resource;
transmitting the indication of the state change of the first resource to a second resource dependent on the first resource;
receiving indication of a state change of the second resource.
